(19) United States
(12) Patent Application Publication
(10) Pub. No.: US 2004/0122807 A1
(43) Pub. Date: Jun. 24, 2004

(54) Methods and systems for performing search interpretation

(76) Inventors: Darin E. Hamilton, Creve Coeur, IL (US); John W. Gardner, East Peoria, IL (US); Paul E. McKim, Edwards, IL (US)

Correspondence Address: Finnegan, Henderson,, Farabow, Garrett & Dunner, L.L.P., 1300 I Street, N.W., Washington, DC, 20005-3315, US

(21) Appl. No.: 10/327,666

(22) Filed: Dec. 24, 2002

(51) Int. Cl. G06F 7/00

(52) U.S. Cl. 707/3

(57) ABSTRACT

A method and system is provided for retrieving information. In one embodiment, the method may include establishing a query and searching a first database in response to said query to obtain a first search result. Also, the method includes searching a second database in response to said query and said first search result and retrieving said information in response to said second search. Further, a local database system may control access to a user providing the query based on an affiliation between the user and an entity associated with the local database system.

### TECHNICAL FIELD

This invention relates generally to, database processing systems, and more particularly to systems, methods, and articles of manufacture for performing search interpretation in a distributed database system environment.

### BACKGROUND

The increase in the popularity and capabilities of network communications, such as Wide Area Network (WAN) and Local Area Network (LAN) communication configurations, have affected many technologies. Among these technologies, data search and retrieval systems have evolved to provide more efficient and economical data access services to users. These search and retrieval systems may be implemented in a number of different configurations. In one configuration, external, or remote, database systems are used by local database systems to supplement search operations. Although a local database system may access an external database system to retrieve externally generated results, problems exist with harnessing the resources of both local and external databases to perform effective search operations.

Attempts have been made to combine the resources of local and external database systems to increase the effectiveness of search operations. One type of such a database system is described in U.S. Pat. No. 6,338,056 issued on Jan. 8, 2002. The search system described in this '056 patent uses indices from an external database to locate information in a local relational database. In response to a query, one or more object identifiers are retrieved from an index in the external database. The object identifiers are used by a local database engine to retrieve identifiers from an index in the local relational database. The identifiers are used by the local database engine to retrieve one or more rows of information from a table in the relational database. Although the system described in the '056 patent makes use of an external and local database system, the system is limited to indexing semi-structured data (e.g., image files) in a relational database system and does not effectively perform the interpretation of search results for local database information.

In addition to the shortcomings indicated above, environments that implement external database systems may also experience inconsistent result interpretation. For example, today, users from a common entity, such as a business entity, access external database systems to retrieve data that is typically not available in a local database. In some instances, the external database system is not affiliated with the business entity. Accordingly, the business entity does not have control over how search results received from the external database system are generated and interpreted by requesting users. For example, when search results received from the external database involve user intuition, such as interpreting government regulations and standards and how they apply to a particular product, multiple users from the same business entity may interpret the results differently. This may lead to inconsistent interpretations and may be costly in terms of wasted man hours to the business entity.

Methods, systems, and articles of manufacture consistent with certain embodiments of the present invention are directed to solving one or more of the problems set forth above.

### SUMMARY OF THE INVENTION

A method and system is provided for retrieving information. In one embodiment, the method may include establishing a query and searching a first database in response to said query to obtain a first search result. Also, the method includes searching a second database in response to said query and said first search result and retrieving said information in response to said second search.

### BRIEF DESCRIPTION OF THE DRAWINGS

The accompanying drawings, which are incorporated in and constitute a part of this specification, illustrate several aspects of the invention and together with the description, serve to explain the principles of the invention. In the drawings:

FIG. 1 illustrates an exemplary system that may be configured to perform certain functions consistent with embodiments of the present invention;

FIG. 2 illustrates a flowchart of an exemplary search interpreting process consistent with embodiments of the present invention;

FIG. 3 illustrates an exemplary basic search query template consistent with embodiments of the present invention;

FIG. 4 illustrates an exemplary advanced search query template consistent with embodiments of the present invention;

FIG. 5 illustrates an exemplary results document corresponding to a standards search type query consistent with embodiments of the present invention;

FIG. 6 illustrates an exemplary results document corresponding to a product search type query consistent with embodiments of the present invention;

FIG. 7 illustrates an exemplary results document corresponding to a combined search type query consistent with embodiments of the present invention;

FIG. 8 illustrates an exemplary results document with additional product information consistent with embodiments of the present invention;

FIG. 9 illustrates an exemplary results document with interpretation data consistent with embodiments of the present invention;

FIG. 10 illustrates an exemplary system access table consistent with embodiments of the present invention;

FIG. 11 illustrates an exemplary override table consistent with embodiments of the present invention;

FIG. 12 illustrates a flowchart of an exemplary security access process consistent with embodiments of the present invention; and

FIG. 13 illustrates a flowchart of an exemplary override security access process consistent with embodiments of the present invention

### DETAILED DESCRIPTION

Reference will now be made in detail to the exemplary embodiments of the invention, which are illustrated in the accompanying drawings. Wherever possible, the same reference numbers will be used throughout the drawings to refer to the same or like parts.

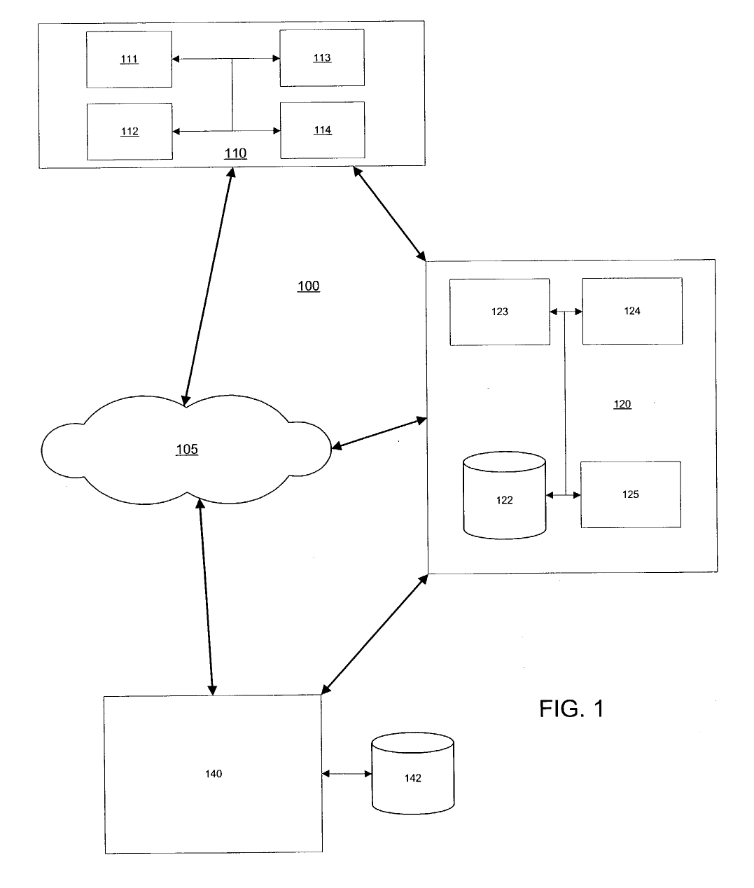

FIG. 1 illustrates an exemplary system 100 in which features and principles consistent with the present invention may be implemented. As shown in FIG. 1, system 100 may include a plurality of modules that perform various functions. In one embodiment of the present invention, system 100 may include a network 105, user system 110, local database system 120, and an external database system 140.

Network 105 may be any type of network that facilitates communications between remote components. For example, network 105 may be a local area network (LAN), a wide area network (WAN), a dedicated intranet, the Internet, and/or a wireless network.

User system 110 is a computing system that is operated by a user. User system 110 may include, for example, a processor 111, memory, 112, display device 113, and an interface device 114. Processor 111 may be one or more processor devices, such as a microprocessor, laptop computer, desktop computer, workstation, mainframe, etc. that execute program instructions to perform various functions. Memory 112 may be one or more storage devices that maintain data (e.g., instructions, software applications, etc.) used by processor 111. In one embodiment of the present invention, memory 112 includes browser software that enables user system 110 to retrieve content from external sources, such as local database system 120. Display device 113 may be any known type of display device that presents information to the user operating user system 110. Interface device 114 may be one or more known interface modules that facilitate the exchange of data between the internal components of user system 110 and external components, such as local database system 120. Further, interface device 114 may include a network interface device that allows user system to receive and send data to and from network 105.

Local database system 120 may be a computing system that performs various functions. In one embodiment, local database system 120 may be configured to process query requests received from user system 110 to retrieve information associated with one or more products provided by a business entity. A product, as used herein, may represent any type of physical good that is designed, developed, manufactured, and/or delivered by a source, such as, for example, a manufacturer or a distributor. For example, a product may be associated with types of industrial vehicles, such as front end loaders, tractors, etc. Additionally, a product may be a non-physical object, such as an electronic document that is created and maintained as program code. Further, a product may be a service, such as a financial service (e.g., loans, stocks, etc.). Further, local database system 120 may represent the source of a product, such as a manufacturer. Local database system 120 may include a local database 122, processor 123, a memory module 124, and an interface module 125. Local database 122 may store data that is requested by external or internal sources, such as user system 110. Local database 122 may represent one or more storage devices configured in any type of known storage system configuration that facilitates the locating, accessing, and retrieving of data stored in the storage devices, (e.g., Sybase, Oracle, MySQL, SQL, Access, etc.). In one exemplary embodiment, local database 122 may store information associated with one or more products affiliated with an entity that provides, maintains, develops, and/or markets the products. One skilled in the art would appreciate that the type of data stored in database 122 may vary without departing from the scope of the invention. For instance, local database 122 may store standards information associated with the one or more products included in database 122. For example, local database 122 may store any type of government, industrial, and/or international standards data associated with each product included in database 122.

Processor 123 may be one or more processor devices known in the art, such as a microprocessor, laptop computer, desktop computer, workstation, mainframe, etc. Memory module 124 may represent one or more storage devices that maintain information that is used by processor 123 and/or other entities internal and external to local database system 120. Further, memory 124 may include one or more programs that, when executed by processor 123, perform one or more processes consistent with embodiments of the present invention. In one embodiment, memory 123 includes a search interpretation program that, when executed by processor 123, performs search interpretation functions consistent with an embodiment of the present invention. Interface module 125 may be one or more devices that facilitate the transfer of information between local database system 120 and external components, such as external database system 140.

External database 140 may be a computing system that performs various functions. In one embodiment, external database system 140 may be configured to process query requests received from local database system 120. External database system 140 may include an external database 142 that stores data that may be requested by external sources, such as local database system 120. External database 142 may represent one or more storage devices configured in any type of known storage system configuration that facilitates the locating, accessing, and retrieving of data stored in the storage devices. In one exemplary embodiment, external database system 140 represents an entity that maintains standards information associated with various industrial, government, and/or international standards for one or more products via external database 142. The type of information stored in external database 142 may be more or less expansive than the type of information stored in local database 122. For instance, external database 142 may store standards information on all types of products, while local database 122 may store standards information associated with products affiliated with the entity affiliated with local database system 120.

External database system 140 may include processing and support components (all not shown) that process data requests from external sources, such as local database system 122. For example, external database system 140 may include one or more processors and memory devices including software that, when executed by the one or more processors, perform search processes to locate, access, and retrieve data from database 142.

One skilled in the art would appreciate that system 100 may be implemented in a number of different configurations without departing from the scope of the present invention. For example, systems 110, 120, and 140 may be directly connected, as shown in FIG. 1. Further, additional components may be included in system 100, such as one or more additional external database systems, that may exchange information with each other and local database system 120. Additionally, external database system 140 may be associated with the same business entity that is affiliated with local database system 120. Thus, a globally based business entity may maintain an external database system 140 in one or more locations remote to local database system 120 without departing from the scope of the present invention. Further, user system 110 may be included within local database system 120, thus allowing system 120 to receive an internal query request from a user operating within local database system 120.

In one embodiment of the invention, exemplary system 100 may be configured to process one or more query requests received from user system 110, such that search results obtained from external database system 140 are used to search data in local database system 120. In the exemplary embodiments described below, a query request is associated with standards and regulations corresponding to one or more products of a particular industry, such as commercial vehicles and/or equipment (e.g., tractors, front end loaders, mining vehicles, farm equipment, etc.). One skilled in the art would appreciate that the type of query and the information obtained from the query may vary and the following description applies to these various queries and information.

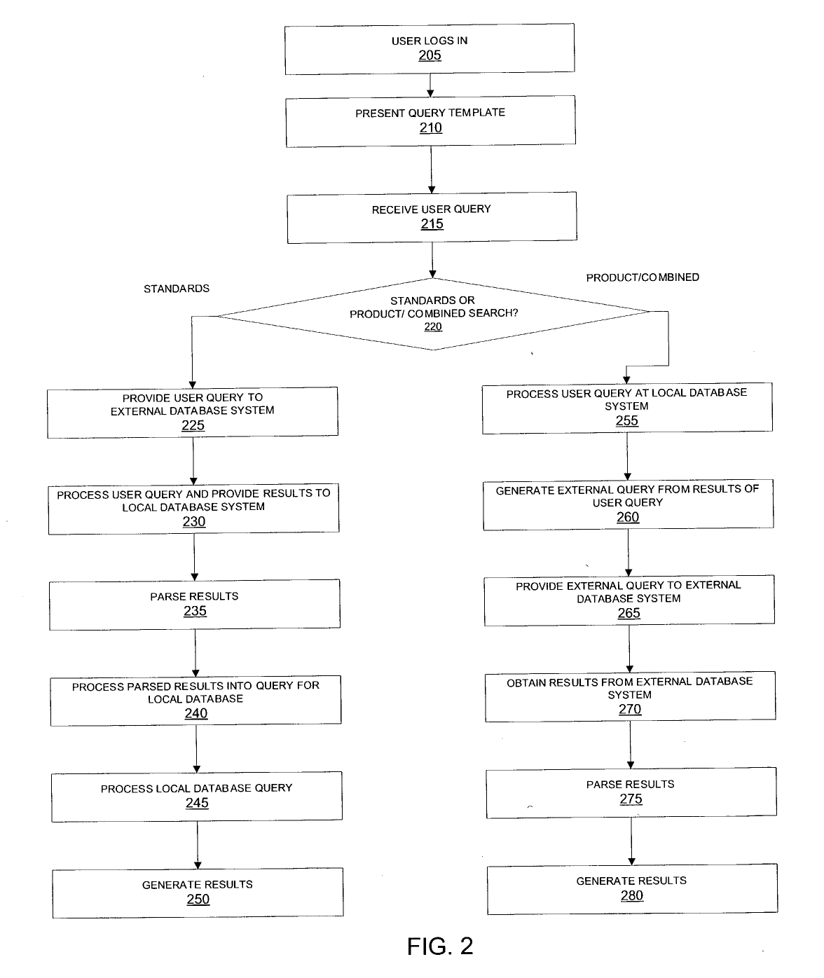

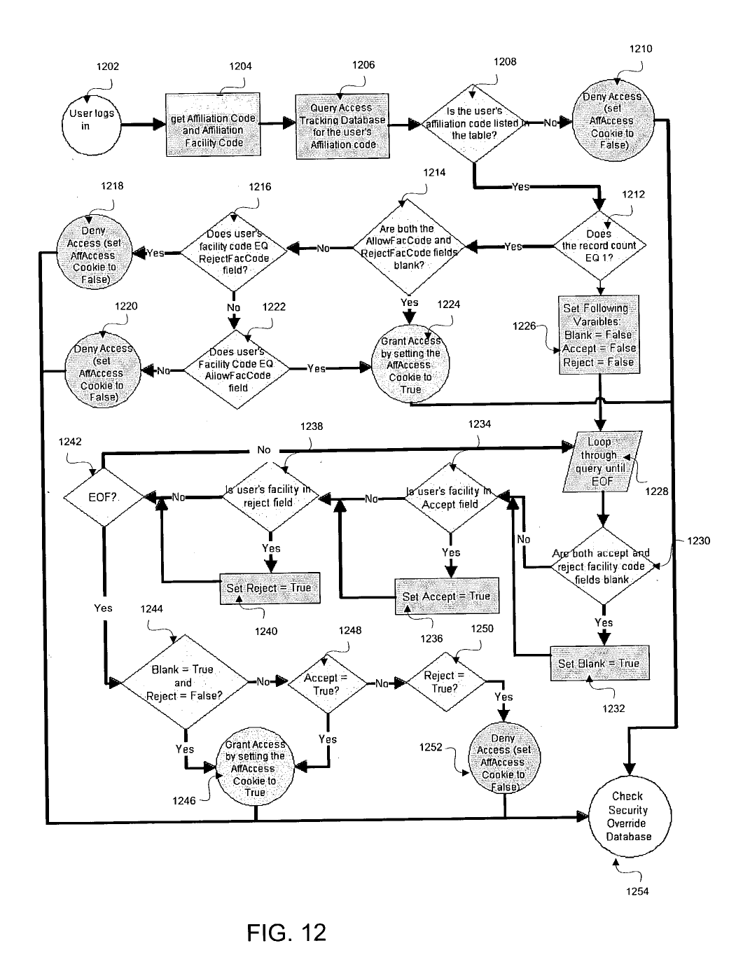

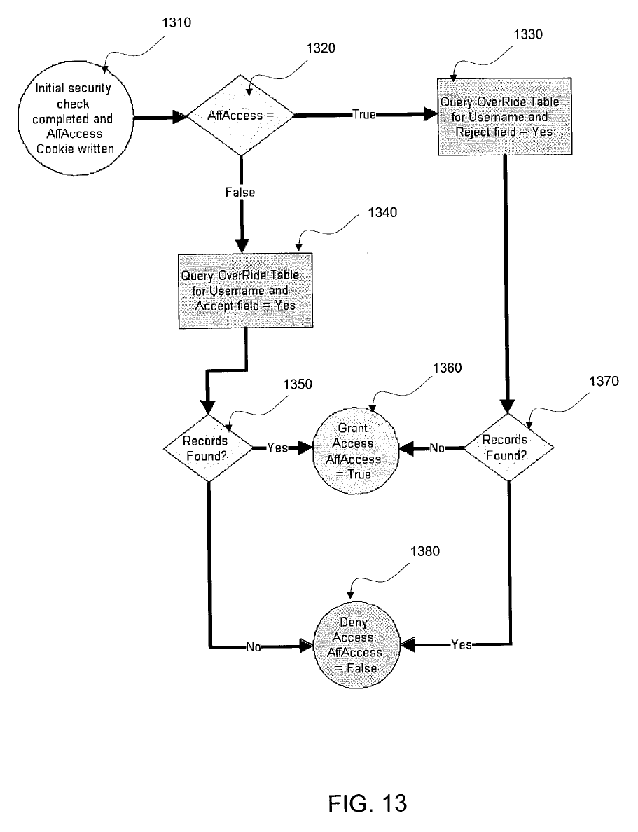

FIG. 2 illustrates a flowchart of an exemplary search interpretation process consistent with an embodiment of the invention. In one embodiment, user system 110 may receive a command from a user to log into local database system 120 (step 205). User system 110 may execute the browser software in memory 112 to access local database system 120 via network 120 to retrieve a login prompt. The prompt may be in the form of a web page or similarly configured content. The format and configuration of the login prompt may vary and is not essential to the operation of this embodiment of the invention. In one embodiment, local database system 120 may implement a security process that controls access to local database system 120 and its services. The exemplary security process is described below with respect to FIGS. 12 and 13.

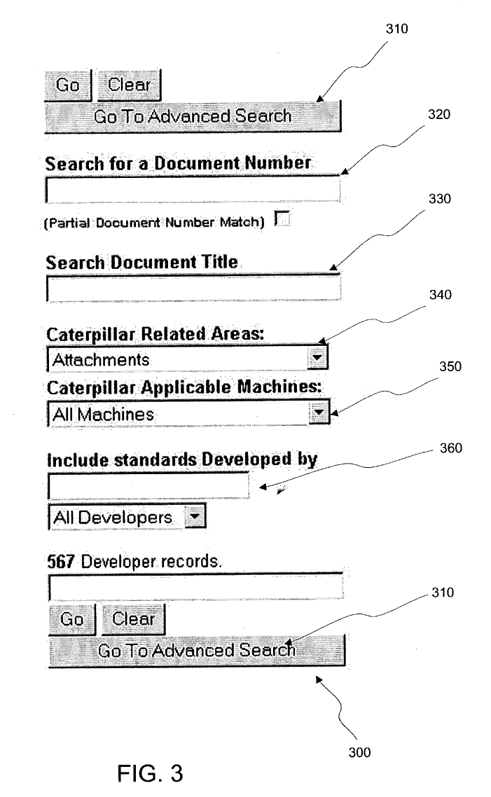

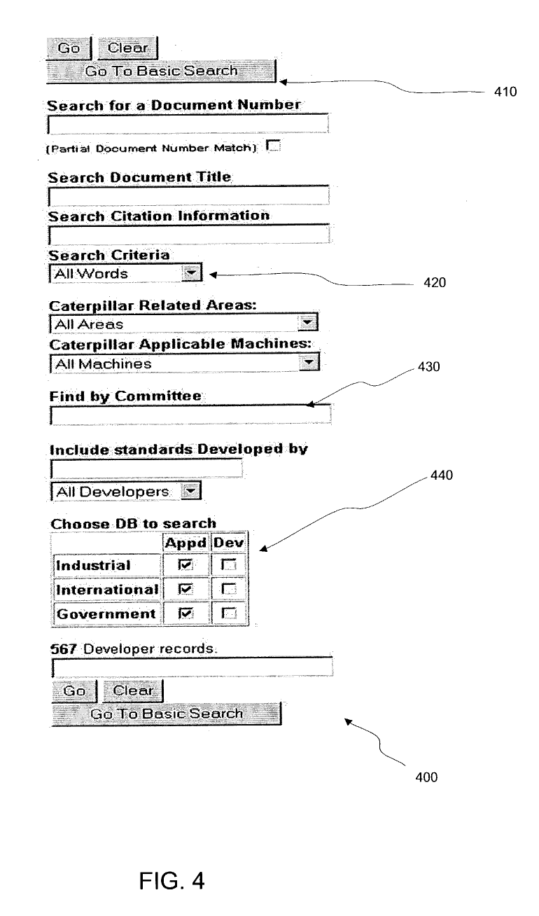

Once the user successfully logs in (e.g., provides a proper login identifier and password), local database system 120 may present a predetermined query template that provides one or more fields that the user may use to formulate a search query (step 210). FIG. 3 shows an exemplary query template 300 that may be provided by local database system 120. As shown in FIG. 3, query template 300 includes several software based buttons 310 (e.g., icons that when selected activate a software process) and fields 320-360 that enable the user to formulate a search query. Button 310 enables the user to switch to an advanced search template that provides more search options for the user. An exemplary advanced search template is shown in FIG. 4 and described further below. Fields 320 and 330 are associated with data that is maintained by external database 140. In this exemplary embodiment, external database 140 maintains documents and information related to standards and/or regulations associated with products in the commercial machine industry. Field 320 is a query field that allows the user to request a particular document number assigned to a document associated with a standard or regulation. Field 330 is a query field that allows the user to request a document title, if known. Fields 340 and 350 are associated with products affiliated with a business entity (e.g., Caterpillar®). Field 340 is a query field that allows the user to request a particular area of interest associated with the business entity, such as “attachments.” Field 350 is a query field that allows the user to request a particular product (e.g., machine) associated with the business entity, such as a backhoe loader, or a default setting to request “all machines” as shown in FIG. 3. Field 360 is a query field that allows the user to request particular sources of developed standards, such as the International Organization for Standardization (ISO).

FIG. 4 shows an exemplary advanced search query template 400. Template 400 includes buttons similar to those shown in template 300 of FIG. 3. For example, button 410 enables the user to switch to the basic search query template 300 shown in FIG. 3. Further, template 400 includes fields that operate in the same manner as those fields included in template 300 of FIG. 3 (e.g., document number, title search fields, etc.). In addition to these related fields, template 400 may also include additional query fields that enable the user to narrow a search based on predetermined criteria. For instance, field 420 is a query field that enables the user to request index or summary information that external database system 140 may maintain for each document or piece of data stored in database 142. For example, the user may select key words associated with the scope or description of a document. Further, field 420 includes a pull down menu function that enables the user to select how the search criteria words are to be used when locating a particular document. For example, if the user selects an exemplary “All Words” option, any word provided by the user must appear in the description of a document in any order, while an “Exact Match” option requires that all of the words provided by the user appear in the order provided by the user.

Another advanced search field in template 400 is field 430. this field is a query field that allows the user to request a particular committee associated with the business entity that provides the products identified in the related areas and/or exemplary machines fields. A committee may be an internal organization of individuals, or a single individual, that the business entity has empowered to set up relationships between the information stored in external database 142 and product information stored in local database 122. For example, a committee may be created by the business entity that is empowered to determine any known standards, rules, regulations, etc. that are applicable to a particular group or single type of product associated with the business entity. Thus, the business entity may have a committee that is assigned to create a relationship data structure that provides information on standards for front end loaders manufactured by the business entity. Also, another committee may be assigned to create a relationship data structure that provides information on standards for track-type tractors manufactured by the business entity. In short, a committee may represent an internal entity that creates categories, groupings, and/or relationships for the information stored in local database 122 and data maintained in database 142, or any other external data source.

Field 440 is a query field that enables the user to request a particular type of database to search when requesting information from external database system 142. For example, in the exemplary scenario where external database system 140 provides information on standards and/or regulations for products, field 440 allows the user to select among industrial, government, and international based standards, as well as standards that are under development or are approved by a governing body. Accordingly, field 440 may be provided by local database system 120 to allow the user to narrow a search request to a particular type of database, or source of data, configured by external database system 140.

Returning back to FIG. 2, once local database system 120 provides a query template to user system 110, the user may formulate a user query that requests information (step 215). System 100 may allow a first database system (e.g., local database system 120 or remote database system 122) to use the query to search its corresponding database to produce a first search result. Based on the first search result and/or the user query, system 100 may also allow a second database system (e.g., local or remote database systems 120, 122, respectively) to search a second corresponding database to produce a second search result. System 100 may then retrieve the requested information in response to the second search result.

Based on the search options available to the user, a user may formulate various types of user queries. In one embodiment, a user may formulate three types of user queries. The first, known as a standards search, requests information corresponding to a type of standard and/or regulation (e.g., document number or title search). The second, known as a product search, requests information corresponding to a particular area and/or product associated with the business entity affiliated with local database system 120. And the third type of query may be a combination of both the first and second type of queries (e.g., the user requests information on a particular standard associated with a particular product). Based on the type of query formulated by the user, local database system 120 may perform different operations (step 220).

Accordingly, if the user query is a standard search (step 220; STANDARD), local database system 120 may forward the user query to external database 140 for processing (step 225). Alternatively, local database system 120 may configure the user query into a format compatible with external database 140 before forwarding the query. External database system 140 receives the user query and performs a search process to locate and retrieve from database 142 information associated with the request included in the standards user query. External database system 140 may package the retrieved information as results and provide the results to local database system 122 (step 230).

Once the results are received, local database system 122 determines whether the results are configured in a format compatible with the search processes performed by system 122. In one embodiment, external database system 140 may provide the results in a particular format, such as in an Active Server Page (ASP). In the event that local database system 120 includes software that is not compatible with the format used by external database system 140, the results are parsed, or translated, into a compatible format for system 120 (step 235). In one embodiment, local database system 120 may use database interface software to facilitate the translation of the results into another format. For example, system 120 may execute a ColdFusion server based software program that translates the results into a format that may be processed by database 122. The ColdFusion program may use ColdFusion Markup Language (CFML) to create tags for accessing database 122. The exemplary program may interpret the commands operating on a server system that controls database 122 (e.g., processor 123), search and query the data in database 122 based on the interpreted commands, and return results in Hyper Text Markup Language (HTML). The ColdFusion program is exemplary and not intended to be limiting to the embodiments of the present invention. Other types of interface programs may be implemented by embodiments of the present invention, such as, for example, Web Sphere, Java JDBC, and ASP based software programs.

Accordingly, local database system 120 parses the results into a second query that is used to locate information stored in local database 122 (step 240). For example, results returned by external database system 140 may include a plurality of documents associated with a type of standard developed by the ISO. Local database system 120 may use the exemplary results to generate a second query that is used to locate products and/or other related information associated with the standards and documents included in the returned results. Therefore, in the above example, database system 120 may generate a query that searches and locates any products that the business entity (or committee) affiliated with system 120 has determined to be associated with the standards included in the results.

Local database system 120 processes the generated query to search for appropriate data from local database 122 (step 245). Once processed, system 120 formulates the results returned from the local database 122 into user results that are provided to user system 110 (step 250). In one embodiment, local database system 120 may generate an HTML based results document that includes information associated with the type of query provided by the user.

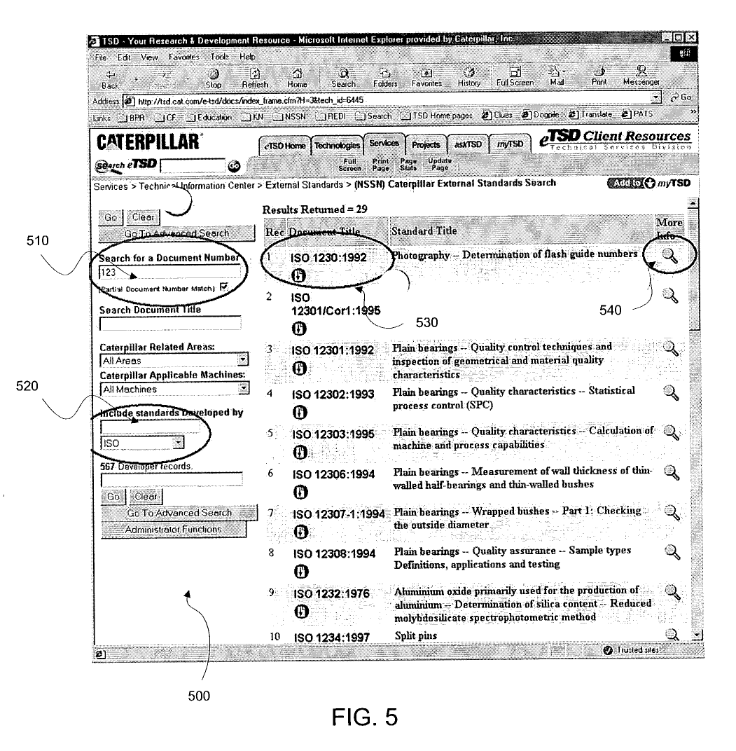

FIG. 5 shows an exemplary results document 500 associated with a standards type of query. As shown, document 500 includes a listing of results corresponding to an exemplary standards type query provided by the user operating user system 110. The exemplary query includes a request in query field 510 for any standards document including the number “123” and a request in query field 520 for standards developed by the ISO. Based on these requests, local database system 120 forwards the user search query to external database system 140 to obtain one or more search results. Based on the received search results, local database system 120 formulates a query. The formulated query is then used to search local database 122 for corresponding products associated with the standards included in the search results provided by external database system 140. Local database system 120 may then generate a results document (e.g., 500) that includes the search results obtained from external database system 140. FIG. 5 shows an exemplary listing of records including documents from the ISO that include the number “123” in the document number (e.g., record number 1, 530). In addition to the results from external database system 140, local database system 120 may generate, for each record, an indicator 540 that represents to the user system 120 additional information regarding the respective standard that relates to the business entity. An indicator is associated in each record based on the results of the formulated query search performed by database system 120. In the exemplary results document 500 shown in FIG. 5, the exemplary icon 540 indicates that system 120 located additional information about the ISO standard in record 1 (e.g., ISO 1230:1992) that relates to the business entity.

Additionally, local database system 120 may include in the results document one or more links to additional information associated with each document included in the results received from external database 140. For example, record 530 may include a link (e.g., document title ISO 1230:1992) that, when activated by a user via an input device (e.g., a mouse pointer), enables user system 110 to download the identified document from external database system 140 either directly or through local database system 120.

As described, the interpretation process shown in steps 225-250 of FIG. 2 enable a user to formulate a standards type query and receive one or more documents associated with standards developed by one or more developing bodies and information associated with the business entity affiliated with local database system 120. Additionally, the interpretation process enables the user to obtain similar and other information from local database system 120 based on product or combination type queries. Steps 255-280 of FIG. 2 are associated with this embodiment of the invention.

Accordingly, if the user formulates a product or combination type query (step 220; PRODUCT/COMBINATION), local database system 120 may process the user query at the local database 122 (step 255). Based on the criteria included in the user query, local database system 120 also generates an external search query (step 260). The external search query is then provided to external database system 140 (step 265). Result data corresponding to the criteria indicated in the external search query is then retrieved from database 142 and sent to local database system 120 (step 270). The results received from external database system 140 are parsed by local database system 120 into a format compatible with the presentation software operating within system 120 (step 275). For example, external database system 140 may send an ASP with the results from its external search to local database system 120. Consequently, local database system 120 may use an interface program, such as a ColdFusion based program, to generate HTML content from the ASP data and use the generated content to create results for presentation to user system 110 (step 280).

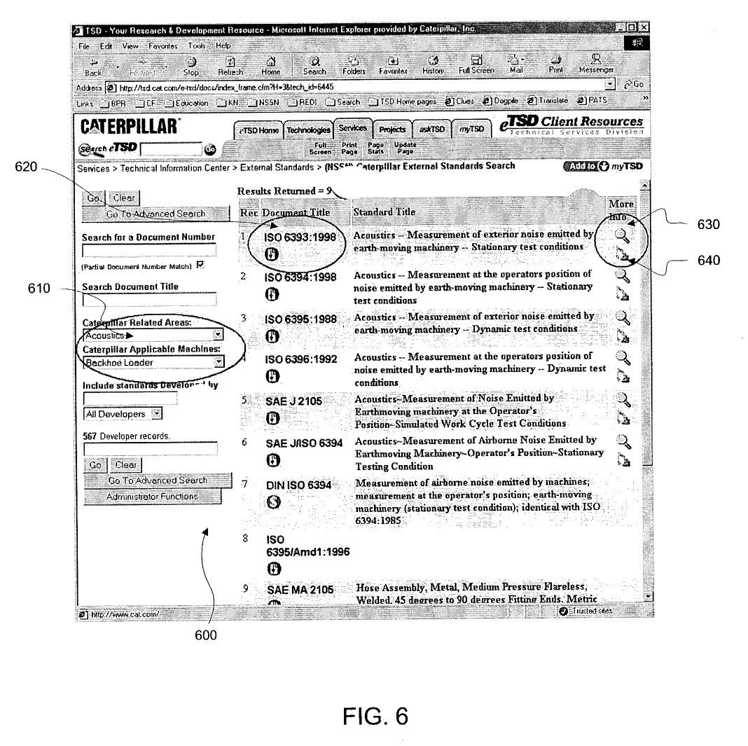

In one embodiment, local database system 120 may generate a results document that includes content including information associated with the results from external database system 140 and local database system 120. FIG. 6 shows an exemplary results document 600 associated with a product search query provided by user system 110. As shown, the exemplary product search query 610 includes a request for information associated with “acoustics” that pertain to a “backhoe loader.” The formulated query 610 is used by local database system 120 to search database 122 for information associated with “acoustics” and “backhoe loaders” related to the business entity. Further, query 610 is used to search external database 140 for standards associated with acoustics and/or backhoe loaders. Results from the external search provided by system 140 are used to generate content for the results document 600. For example, as shown in FIG. 6, document 600 may include a listing of records corresponding to the search results received from external database system 140. Document record 620 shows an exemplary resultant document ISO 6393:1998” that meets the criteria set forth in query 610.

In addition to presenting search results from the external database system search, local database system 120 may also include, for each document record, indicators 630 and 640 representing additional information for the identified standard that relate to the business entity and/or its products. Indicator 630 may represent the same type of indicator 540 illustrated in FIG. 5. Thus, each indicator 630 associated with a corresponding document record may represent additional information regarding the respective standard that relates to the business entity. Indicator 630 may be associated with each record based on the results of the formulated query search performed by database system 120. Similar to indicator 540 in FIG. 5, indicator 630 may indicate that system 120 located additional information about the ISO standard in record 1 (e.g., ISO 6393:1998) that relates to the business entity. Indicator 640 reflects that there is additional information associated with a respective standard on the applicable product selected by the user in query 610 (e.g., backhoe loaders).

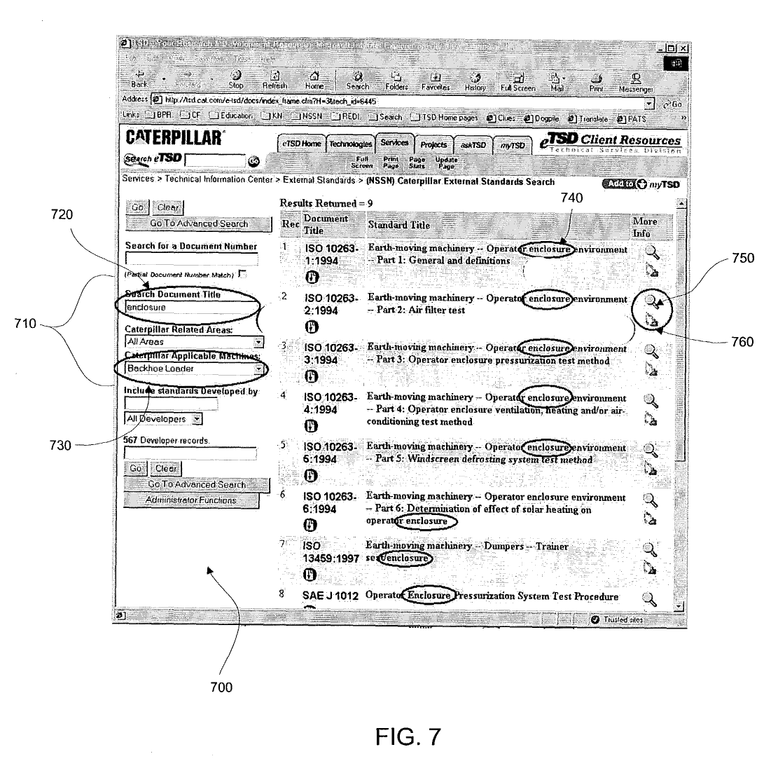

Local database system 120 may also generate a results document based on a combination type query. FIG. 7 shows an exemplary results document 700 that may be generated by system 120 based on an exemplary combination type query 710. As shown, query 710 includes a request in query field 720 for documents that include the word “enclosure” in a document title and a request in query field 730 for backhoe loaders. Document 700 also includes a list of document records corresponding to search results obtained from external database system 140 based on the query field 720 (e.g., enclosure). Accordingly, as shown in FIG. 7, the term “enclosure” 740 is included in the title for each document record listed in results document 700. As with results document 600, document 700 may also include indicators 750 and 760 for each record reflecting additional information regarding a corresponding standard related to some business entity information and applicable product, respectively.

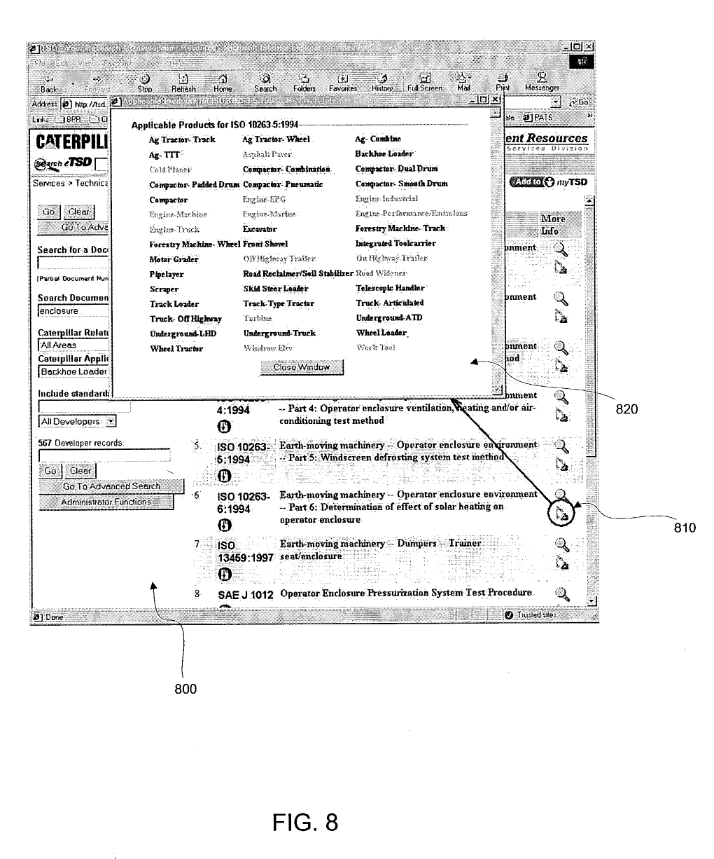

User system 110 may present a results document and also facilitate interactive selections from a user regarding additional information, such as selections of indicators 540, 630, 640, 750, and 760, depending on the type of results document presented. FIG. 8 shows an exemplary document 800 that may be presented to user system 110 by local database system 120 based on a user selection for additional information regarding the business entity affiliated with system 120 (e.g., selection of indicator 540, 630, or 750). As shown, document 800 includes an exemplary window 820 that system 120 may generate based on a selection of an additional information indicator 810. Window 820 may include information associated with data generated by the business entity, such as through one or more committee members, pertaining to the corresponding standard for the document record associated with indicator 810. Accordingly, in the exemplary window 820, information associated with the standard corresponding to document number ISO 10263-5:1994 and how it is interpreted by the business entity is presented in exemplary window 820. Thus, variations of this exemplary embodiment provide a forum from which a business entity may present applicable internal interpretations of data included in external database 142.

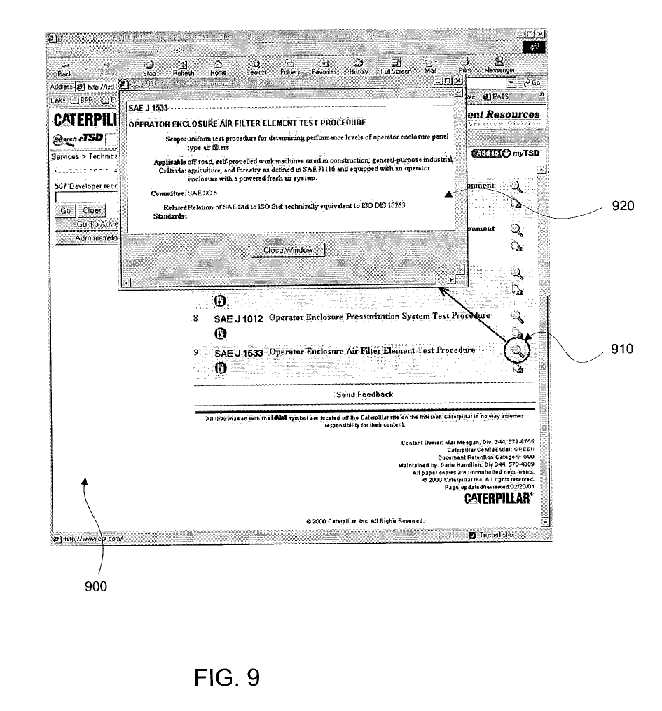

FIG. 9 shows an exemplary document 900 that may be presented to user system 110 by local database system 120 based on a user selection for additional information regarding a product associated with the business entity affiliated with system 120 (e.g., selection of indicator 640 or 760). As shown, document 900 includes an exemplary window 920 that system 120 may generate based on a selection of an additional information indicator 910. Window 920 may include information associated with data compiled by the business entity, such as through committee members, pertaining to one or more products that relate to the corresponding standard for the document record associated with indicator 910. Accordingly, in the exemplary window 920, information associated with the standard corresponding to document number SAE J 1533 and its relation to one or more products associated with the business entity is presented in exemplary window 920. In one embodiment, the applicable products may be listed alone, or may be highlighted to distinguish themselves from other products not associated with the respective standard. Thus, variations of this exemplary embodiment provide a forum from which a business entity may indicate which of its products are applicable to the corresponding standard associated with the selected indicator 910.

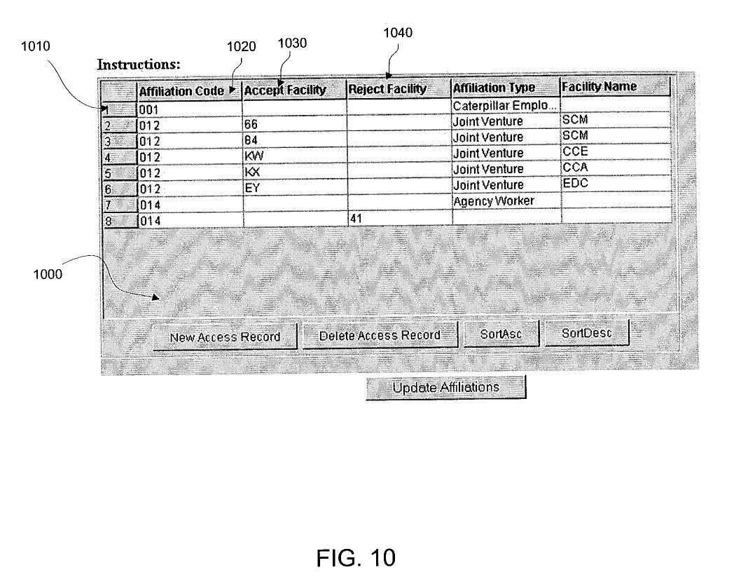

As previously mentioned, local database system 120 may control access to database 122. In one embodiment, local database system 120 may define various access capabilities based on a user's affiliation with the business entity associated with system 120 and store this information in a system access table. A user, such as a system administrator, may define an affiliation code for different types of users and define access rules for each affiliation code. FIG. 10 shows an exemplary security access table within an exemplary user interface that presents a system access edit window 1000 that a user, such as a system administrator, may use to control access to local database 122 and/or external database 142. As shown, window 1000 includes a list of records 1010 and their corresponding affiliation codes 1020 corresponding to information stored in the system access table. An affiliation code may represent a user's affiliation with the business entity, such as an employee, contractor, etc. Thus, a user who has an associated affiliation code of “01” would be recognized by local database system 120 as an employee. An administrator may define, for each affiliation code, access to each facility available from local database system 120. A facility may be a division, or department, of the business entity. In the exemplary system access window 1000, the administrator may allow access by all users with a corresponding affiliation code by keeping the accept and reject facility fields 1030 and 140, respectively, empty. To allow access to a particular facility, an administrator may enter a facility code in field 1030. Further, to prevent access by employees at a particular facility, the administrator enters the facility code in field 1040. Accordingly, in the exemplary window 1000, all employees of the business entity have access to database system 120 while only those “Joint Venture” individuals working at facilities 66, 84, KW, KX, and EY have access. Also, all “Agency Workers” have access except those at facility 41.

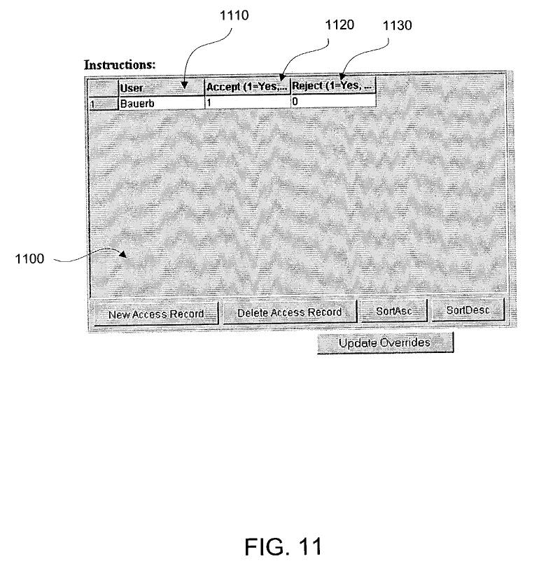

Any type of access control mechanism, format, and interface configuration may be implemented by embodiments of the present invention without departing from the scope of the invention. For example, system 120 may create an override table that overrides the access restrictions defined in the system access table. The override table may enable an administrator to grant or restrict access to individual users. FIG. 11 shows an exemplary override table within a system access window 1100 illustrating this embodiment. As shown, window 1100 allows an administrator to grant or restrict access to a particular user 1110 by selecting field 1120 or 1130, respectively.

FIG. 12 shows an exemplary security access process consistent with an embodiment of the present invention. Local database system 120 may perform the security access process to determine whether to grant or reject access to a user when requesting access to local database system 120. As shown, the security process is performed when a user operating user system 110 attempts to log in to database system 120 (step 1202). In response to the login, system 120 retrieves the affiliation and facility code associated with the user (steps 1204 and 1206). System 120 may then determine whether the user's affiliation code is listed in a system access control table, such as the table shown in the exemplary window 1000 of FIG. 10 (step 1208). If the user's affiliation code is not listed in the table (step 1208; NO), system 120 denies access to the user (step 1210). In one embodiment, system 120 may use software based user relationship code, such as a cookie, as a flag to indicate whether the user has been granted or denied access. In this exemplary embodiment, the denial of access may direct system 120 to set an affiliation access (e.g., AffAccess) cookie to “false.” The security process then proceeds to check the override table (step 1254), described further with respect to FIG. 13.

In the event, however, that the user's affiliation code is listed in the system access table (step 1208; YES), system 120 then determines whether the record count is equal to “1,” indicating there is only one record in the table (step 1212). If the count is equal to “1,” system 120 may then determine whether both the accept and reject facility field in the system access table are blank (step 1214). For example, in FIG. 10, the accept and reject facility fields are blank for the first record. If both the reject and accept facility fields are blank (step 1214; YES), system 120 grants access to the user by, for example, setting the AffAccess cookie to “true” (step 1224) and the security process proceeds to step 1254. On the other hand, if the reject and facility fields are not blank (step 1214; NO), system 120 determines whether the user's facility code equals a facility code listed in the reject facility code field (step 1216). If so (step 1216; YES), system 120 denies access to the user (step 1216) and the security process proceeds to step 1254. However, if the user's facility code does not equal a facility code listed in the reject facility code field (step 1216; NO), system 120 determines whether the user's facility code is included in the accept facility code field (step 1222). If so, then system 120 grants access to the user (step 1224). If not, system 120 denies access to the user (step 1220).

Returning back to step 1212, in the event the record count for the system access table is not equal to “1,” system 120 sets one or more variables that are used by the security process to determine whether access for the user should be granted or denied. In one embodiment, system 120 sets a “blank” variable, an “accept” variable, and a “reject” variable to “false” (step 1226). System 120 may then loop through each record until the End of File (EOF) is reached (step 1228) (e.g., the end of the system access table). System 120 then determines whether both the accept and reject facility fields for the system access table are blank (step 1230), and if so (indicating every facility associated with a listed affiliation code has been granted access to system 120), sets the “blank” variable to “true” (step 1232). However, if the accept and reject facility fields are not blank (step 1230; NO), system 120 determines whether the user's facility code is included in the accept facility field (step 1234). If the user's facility is included in the accept field (step 1234; YES), system 120 sets the accept variable to “true” (step 1236). However, if the user's facility is not in the accept field (step 1234; NO), system 120 determines whether the user's facility code is the reject field (step 1238), and if so, sets the reject variable to “true.” On the other hand, if the user's facility code is not in the reject field (step 1238; NO), system 120 determines whether the end of the system access file has been processed (step 1242), and if not, returns to step 1228. If the end of the file has been reached (step 1242; YES), system 120 determines whether the blank variable is set to “true,” and the reject variable is set to “false” (step 1244). If these two conditions are met (step 1244; YES), system 120 grants access to the user (step 1246) and the security process proceeds to step 1254. On the other hand, if the two conditions are not met (step 1244; NO), system 120 determines whether the accept variable is set to “true” (step 1248). Is so, access is granted (step 1246), and if not, system 120 determines whether the reject variable is set to “true” (step 1250). If the reject variable is set to “true,” system 120 denies access to the user (step 1252) and the security process proceeds to step 1254.

At step 1254, local database system 120 may check the override table to determine whether an administrator, or other source, has overridden any of the access control definitions in the security access table. FIG. 13 shows an flowchart of an exemplary override security access process consistent with this embodiment of the present invention. At step 1310, system 120 recognizes that the security process illustrated in FIG. 12 has been completed and the exemplary AffAccess cookie written indicating whether access is denied or accepted. If the AffAccess variable is set to true (step 1320; TRUE), system 120 queries the override table to determine whether a reject field corresponding to the user's username has been set (step 1330). However, if the AffAccess variable is set to “false” (step 1320; FALSE), system 120 queries the override table to determine whether the accept field corresponding to the user's username is set (step 1340). If the reject field is set (Step 1370; YES), system 120 overrides the security process decision to grant access and denies access (step 1380). Conversely, if the reject field is not set (step 1370; NO), access is granted (Step 1360). Further, if the accept field is set (step 1350; YES), access is also granted (step 1360). However, if the accept field for the user's username is not set (step 1350; NO), access is denied (step 1380).

Accordingly, local database system 120 may perform various security procedures to ensure valid users have access to database 122 and data obtained from external database 142.

Industrial Applicability

Methods, systems, and articles of manufacture consistent with embodiments of the present invention enable a system to use the results of a search process from an external database to locate and retrieve information from a local database system. The described system is applicable to a variety of external and local database systems. In one embodiment, the information retrieved from the local database is related to information in the results from the external database and internal information provided by an entity affiliated with the local database. Further, the local database system may control access to a requesting user.

Although the exemplary embodiments described above are associated with a business entity that provides products related to standards and/or regulation information stored in an external database, the embodiments are applicable to other types of data. For example, the business entity affiliated with local database system 120 may be associated with any type of industry, such as a document publishing industry, a web-based content provider industry, a financial services industry, etc. Moreover, the type of data stored in external database 142 is not limited to standards and regulations. For instance, external database 142 may include data associated with any type of industry, such as non-commercial, commercial, governmental, private, etc.

Also, in other embodiments, local database system 120 may perform various other functions when performing the search interpretation process shown in FIG. 2. For example, when system 120 formulates a query in a product search type query scenario, system 120 may formulate variations of an applicable product requested by a user. For instance, if a user requested “backhoe loaders” in query field 350 of FIG. 3 (e.g., applicable machines), system 120 may search for information associated with backhoe loaders, but also similar types of machines, such as front end loaders, etc.. Further, when system 120 formulates a query for external database system 140, system 120 may include commands to search for information associated with the requested applicable product (e.g., backhoe loader).

In another embodiment of the invention, local database system 120 may perform automatic updating and/or manual updating of local database 122. For example, a user, such as a committee member, may update data for a corresponding standard or regulation that is applicable to one or more products provided by the business entity affiliated with system 120. Alternatively, system 120 may perform automatic updating of the data in database 122. For instance, if the business entity develops a new product, the specifications of the product may be provided to an update program that automatically generates information regarding the new product in database 122. Further, the update program may perform a correlation search to include information in database 122 associated with one or more standards and/or regulations related to the new product.

In yet another embodiment of the present invention, system 120 may automatically update the system access and override tables that control access to system 120. For example, when a new employee of the affiliated business entity begins work in a particular facility, a security update program may automatically create affiliation and facility codes for the new employee. Based on the job description for the new employee, the update program may grant or deny access to database system 120.

The sequence of the processes performed in FIGS. 2, 12 and 13 are exemplary. That is, additional or fewer steps may be performed and/or different sequences may be performed by system 120. Further, system 120 may perform different types of processes to receive queries from users and formulate queries for external database system 140.

The configuration and format of the query templates, search pages, results documents, etc. illustrated in FIGS. 3-9 of this application may vary. Embodiments of the present invention may implement various types of user interfaces to facilitate receiving and processing query requests. Further, the type of information being searched may also affect the type of search query fields to include in a user interface, if implemented. For instance, embodiments of the present invention may allow different types of entities to be affiliated with different types of data that is maintained by local database system 120, such as documents created, published, stored, and/or marketed by a user, group of users, organization, and/or business entity. Accordingly, for example, query fields 340 and 350 in FIG. 3 may be altered to request areas of interest associated with the exemplary documents stored in local database system 120 and field 360 may request particular documents, classification of documents, etc.

The features, aspects and principles of the present invention may be implemented in various environments. Such environments and related applications may be specially constructed for performing the various processes and operations of the invention. The processes disclosed herein are not inherently related to any particular system, and may be implemented by a suitable combination of electrical-based components. Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. A method of retrieving information, comprising:
establishing a query;
searching a first database in response to said query, said searching resulting in a first search result;
searching a second database in response to said query and said first search result; and
retrieving said information in response to said second search.

2. The method of claim 1, wherein the information includes information stored in the second database that is related to the first result.

3. The method of claim 1, wherein the first database is maintained by a first entity and the second database is maintained by a second entity, wherein the first entity is remote from the second entity.

4. The method of claim 3, wherein the second database includes data associated with one or more products provided by the second entity.

5. The method of claim 4, wherein the first entity is a database system that maintains standards information associated with a plurality of products including the one or more products provided by the second entity.

6. The method of claim 5, wherein the second database includes data corresponding to data stored in the first database.

7. The method of claim 1, wherein searching a second database includes:
parsing the first search result;
generating a second query based on the parsed first search result; and
searching the second database in response to the generated second query.

8. The method of claim 1, wherein the information is located in the second database and retrieving said information includes:
providing the information and data related to the first search result to a user.

9. The method of claim 1, wherein the method further includes:
providing a user interface that includes the information and data reflecting the first result.

10. The method of claim 1, wherein the information includes interpretation data that is formulated by one or more users, wherein the interpretation data includes data reflecting information stored in the first database and the second database.

11. The method of claim 10, wherein the interpretation data includes data that corresponds to the established query.

12. A method for providing information in a distributed computing system including a first database storing first information and a second database storing second information, the method comprising:
receiving a user query including search criteria from a user;
determining whether the search criteria includes data corresponding to at least one of the first and second information;
searching for information corresponding to the search criteria based on the determination, wherein searching includes:
when the data included in the search criteria corresponds to the first information,
searching the first database based on the user query to obtain a first search result from the first information, searching the second database based on the first search result to obtain a second search result from the second information, and generating user results from the first and second search results; and
when the data included in the search criteria corresponds to the second information,
searching the second database based on the user query to obtain a third search result from the second information, searching the first database based on the user query to obtain a fourth search result from the first information, and generating user results from the third and fourth search results; and
providing the user results to the user.

13. The method of claim 12, wherein determining whether the search criteria includes data corresponding to at least one of the first and second information includes:
determining whether the search criteria includes a request for product information included in the second information.

14. The method of claim 12, wherein searching the second database based on the first search result to obtain a second search result includes:
parsing the first search result;
formulating a second query based on the parsed first search result; and
searching the second database using the second query.

15. The method of claim 12, wherein the second search result includes product information corresponding to one or more products provided by a business entity affiliated with the second database.

16. The method of claim 15, wherein the first information includes standards information corresponding to standards for each of a plurality of products including the one or more products provided by the business entity.

17. The method of claim 15, wherein the product information includes an interpretation of the respective standards for the one or more products provided by the business entity.

18. The method of claim 12, wherein the second information includes an interpretation of data included in the first information, wherein the interpretation is formulated by an entity affiliated with the second database.

19. The method of claim 18, wherein providing the user results to a user includes:
providing a user interface including a representation of at least one of the first, second, third, and fourth search results.

20. The method of claim 19, wherein the representation includes an interactive indicator associated with at least one of the second and third results and the method further includes:
providing data included in the second information in response to a selection of the indicator.

21. The method of claim 19, wherein the representation includes an interactive indicator associated with at least one of the first and fourth results and the method further includes:
providing data included in the first information in response to a selection of the indicator.

22. The method of claim 12, wherein receiving a user query including search criteria from a user includes:
determining whether the user is authorized to access the second database based on an affiliation between the user and an entity associated with the second database.

23. The method of claim 12, wherein receiving a user query including search criteria from a user includes:
determining whether the user is associated with a facility of an entity affiliated with the second database; and
determining whether the facility is allowed or denied access to the second database.

24. A system for providing information, comprising:
a user system configured to provide a user query formulated by a user;
an external database system configured to search for external database information from an external database; and
a local database system configured to receive the user query and determine whether the user query is one of a first or second type of query,
wherein when the user query is a first type, the local database system provides the user query to the external database system to obtain a first search result from the external database, searches a local database based on the first search result to obtain a second search result, and generates user results from the first and second search results, and
wherein when the user query is a second type, the local database system searches the local database based on the user query to obtain a third search result, provides an external query to the external database system based on the user query to obtain a fourth search result from the external database, and generates user results from the third and fourth search results.

25. The system of claim 24, wherein the local database system is configured to determine whether the user query includes a request for information associated with one or more products provided by an entity affiliated with the local database system.

26. The system of claim 24, wherein the local database system is configured to parse the first search result, formulate a second query based on the parsed first search result, and search the local database using the second query.

27. The system of claim 24, wherein the second search result includes product information corresponding to one or more products provided by a business entity affiliated with the local database system.

28. The system of claim 27, wherein the external database includes standards information corresponding to standards for each of a plurality of products, including the one or more products provided by the business entity.

29. The system of claim 27, wherein the product information includes an interpretation of the respective standards for the one or more products provided by the business entity.

30. The system of claim 24, wherein the local database includes information reflecting an interpretation of data included in the external database, wherein the interpretation is formulated by an entity affiliated with the local database system.

31. The system of claim 30, wherein the local database system is configured to provide the user results to the user system.

32. The system of claim 24, wherein the local database system is configured to provide a user interface including an interactive indicator associated with at least one of the second and third results that, when selected, provides data included in the local database system.

33. The system of claim 24, wherein the local database system is configured to provide a user interface including an interactive indicator associated with at least one of the first and fourth results that, when selected, provides data included in the external database.

34. The system of claim 24, wherein the local database system is configured to determine whether the user is authorized to access the local database system based on an affiliation between the user and an entity associated with the local database system.

35. The system of claim 24, wherein the local database system is configured to determine whether the user is associated with a facility of an entity affiliated with the local database system and determine whether the facility is allowed or denied access to the local database.

36. A computer-readable medium including instructions for performing a method, when executed by a processor, for retrieving information, the method comprising:
establishing a query;
searching a first database in response to said query, said searching resulting in a first search result;
searching a second database in response to said query and said first search result; and
retrieving said information in response to said second search.

37. A computer-readable medium including instructions for performing a method, when executed by a processor, for providing information in a distributed computing system including a first database storing first information and a second database storing second information, the method comprising:
receiving a user query including search criteria from a user;
determining whether the search criteria includes data corresponding to at least one of the first and second information;
searching for information corresponding to the search criteria based on the determination, wherein searching includes:
when the data included in the search criteria corresponds to the first information,
searching the first database based on the user query to obtain a first search result from the first information, searching the second database based on the first search result to obtain a second search result from the second information, and generating user results from the first and second search results; and
when the data included in the search criteria corresponds to the second information,
searching the second database based on the user query to obtain a third search result from the second information, searching the first database based on the user query to obtain a fourth search result from the first information, and generating user results from the third and fourth search results; and
providing the user results to the user.
